(19) United States
(12) Patent Application Publication
(10) Pub. No.: US 2025/0325096 A1
(43) Pub. Date: Oct. 23, 2025

(54) TOOTHBRUSH PEN

(71) Applicant: Jose Alfredo Vergara, Dalton, GA (US)

(72) Inventor: Jose Alfredo Vergara, Dalton, GA (US)

(21) Appl. No.: 19/185,237

(22) Filed: Apr. 21, 2025

Related U.S. Application Data
(60) Provisional application No. 63/636,726, filed on Apr. 20, 2024.

(51) Int. Cl. A46B 15/00; A46B 9/04; A46B 11/00; B43K 7/12

(52) U.S. Cl. CPC A46B 15/0055; A46B 9/04; A46B 11/0027; B43K 7/12; A46B 2200/1066

(57) ABSTRACT

A toothbrush pen comprising a pen apparatus having a pin tip housing ink and an outer body defining a hollow enclosure for housing a removable toothbrush apparatus. In this way, the toothbrush pen is an apparatus that looks and functions like a pen but also houses a toothbrush.

### CROSS REFERENCE TO RELATED APPLICATION

This application claims the benefit of U.S. Patent Application Ser. No. 63/636,726, which was filed on Apr. 20, 2024, and is incorporated herein by reference in its entirety.

### TECHNICAL FIELD

This disclosure relates to implementations of an apparatus that looks and functions like a pen but also houses a toothbrush and toothpaste.

### BACKGROUND

It is recommended that a person brush his/her teeth each time after eating. However, a person often does not have access to a toothbrush and/or toothpaste to brush his/her teeth. But, a person does typically carry a pen.

### BRIEF DESCRIPTION OF THE DRAWINGS

FIG. 1 illustrates an implementation of the outer body of an example toothbrush pen according to the present disclosure.

FIG. 2 illustrates an exploded view of the toothbrush pen according to the present disclosure.

FIG. 3 illustrates an exploded view of the pen barrel and the pen tip of the toothbrush pen with the pen tip retracted according to the present disclosure.

FIG. 4 illustrates a view of the toothbrush pen showing the pen cap and the toothbrush apparatus unhoused from the pen barrel and the pen cap according to the present disclosure.

FIG. 5 illustrates views of the pen tip of the toothbrush pen with the pen tip retracted and extended according to the present disclosure.

FIG. 6 illustrates a view of the toothbrush pen showing the portion of the toothbrush apparatus that is housed by the pen cap and by the pen barrel (not shown), which is received by the pen cap (such as shown in FIG. 7), according to the present disclosure.

FIG. 7 illustrates a view of the toothbrush pen showing the portion of the toothbrush apparatus of the toothbrush pen that is housed by the pen cap and by the pen barrel, which is received by the pen cap, according to the present disclosure.

FIG. 8 illustrates an implementation of an example pen barrel according to the present disclosure.

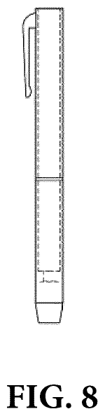

FIG. 9 illustrates an implementation of another example toothbrush pen having the pen barrel of FIG. 8 according to the present disclosure.

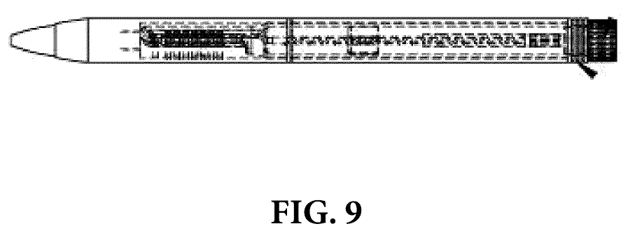

FIG. 10 illustrates an exploded view of the example toothbrush pen of FIG. 9.

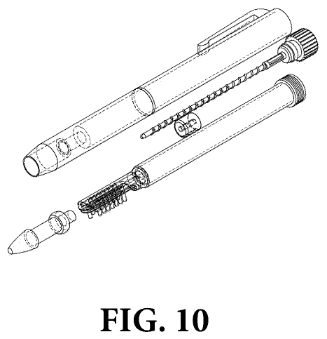

### DETAILED DESCRIPTION

Implementations of a toothbrush pen are provided. In some implementations, the toothbrush pen comprises a pen apparatus, a toothbrush apparatus, and a pen cap.

In some implementations, the toothbrush pen is an apparatus that looks and functions like a pen but also houses a toothbrush. In some implementations, the toothbrush pen also houses toothpaste. In some implementations, the toothbrush pen can apply the toothpaste to the toothbrush.

In some implementations, the toothbrush pen is a novel apparatus comprising a pen apparatus having an outer body defining a hollow enclosure for housing a removable toothbrush apparatus.

In some implementations, the toothbrush pen can be stored anywhere a pen can be stored, such as in a shirt pocket, purse, etc., and then can be easily retrieved to use as a toothbrush with toothpaste when needed. In this way, in some implementations, a toothbrush and toothpaste are readily available whenever a user needs it to brush his/her teeth, such as after eating.

In some implementations, a method of using the toothbrush pen comprises removing the toothbrush apparatus from the pen apparatus and using the toothbrush apparatus to brush a user's teeth. In some implementations, the method further comprises returning the toothbrush apparatus into the pen apparatus and using the toothbrush pen as a writing pen as needed.

In some implementations, the method further comprises storing the toothbrush pen anywhere a pen can be stored, such as a shirt pocket, purse, etc. and then retrieving the toothbrush apparatus from the toothbrush pen to use as a toothbrush with toothpaste when needed to brush the user's teeth, such as after eating.

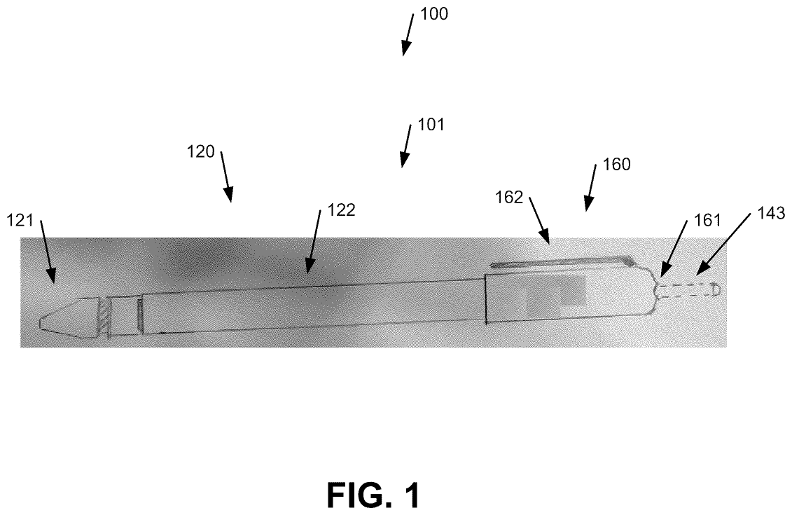

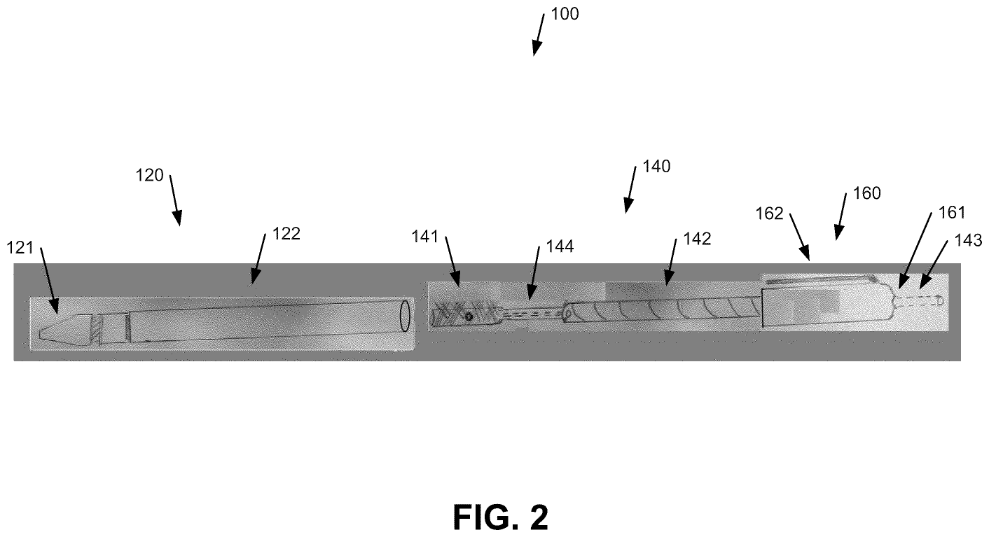

FIG. 1 illustrates an implementation of the outer body 101 of an example toothbrush pen 100 according to the present disclosure. FIG. 2 illustrates an exploded view of the toothbrush pen 100 according to the present disclosure.

As shown in FIG. 2, in some implementations, the toothbrush pen 100 comprises a pen apparatus 120, a toothbrush apparatus 140, and a pen cap 160.

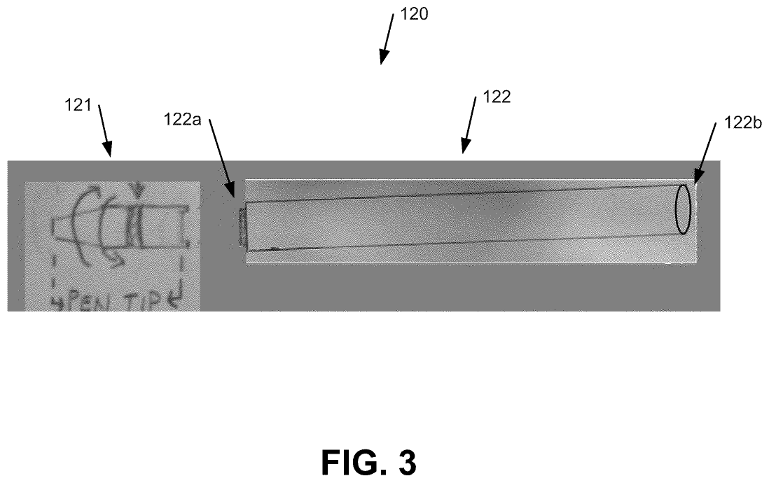

As shown in FIG. 3, in some implementations, the pen apparatus 120 comprises a pen tip 121 and a pen barrel (“hollow barrel”, “barrel”) 122, wherein the pen barrel 122 has a closed end 122a and an open end 122b.

In some implementations, the pen barrel 122 and the pen cap 160 form the outer body 101 of the toothbrush pen 100.

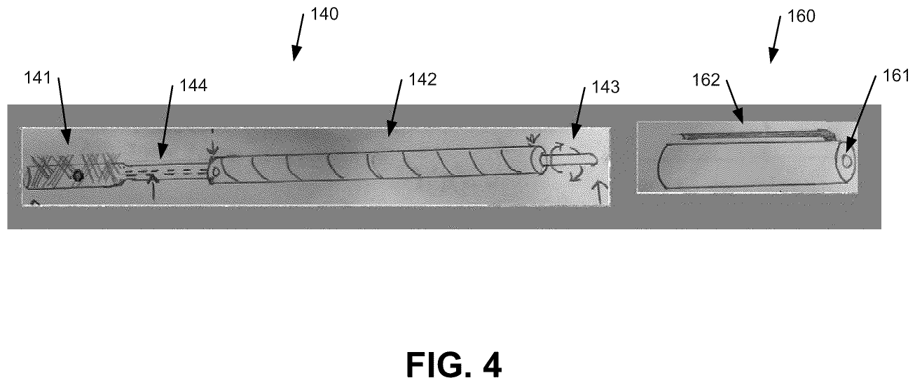

FIG. 4 illustrates a view of the toothbrush pen 100 showing the pen cap 160 and the toothbrush apparatus 140 unhoused from the pen barrel 122 and the pen cap 160 according to the present disclosure. As shown in FIGS. 2 and 4, in some implementations, the toothbrush apparatus 140 comprises a toothbrush head 141 and a toothpaste chamber 142 attached to the toothbrush head 141.

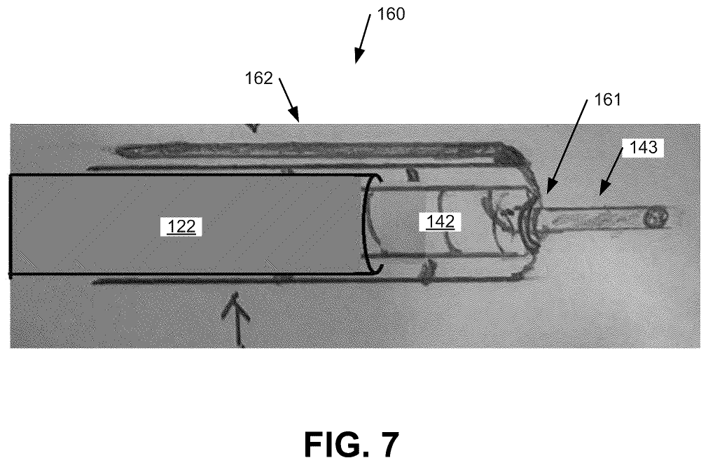

FIG. 7 illustrates a view of the toothbrush pen 100 showing the portion of the toothbrush apparatus 140 that is housed by the pen cap 160 and by the pen barrel 122, which is received by the pen cap 160, according to the present disclosure. As shown in FIGS. 1, 2, and 7, in some implementations, the open end 122b of the hollow barrel 122 is configured to receive and house a portion of the toothbrush apparatus 140 by inserting the toothbrush head 141 into the open end 122b of the hollow barrel 122.

In some implementations, the pen tip 121 attaches to the closed end 122a of the hollow barrel 122.

In some implementations, the pen cap 160 is configured to receive the end of the toothpaste chamber 142 opposite the toothbrush head 141.

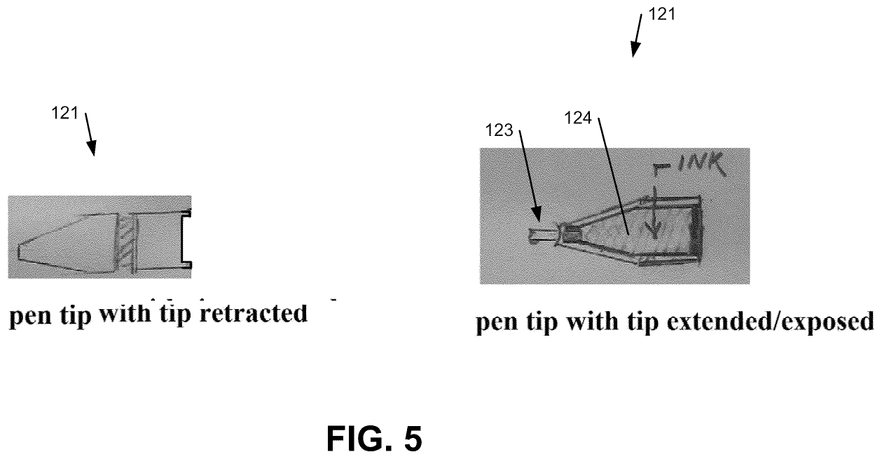

FIG. 3 illustrates an exploded view of the barrel 122 and the pen tip 121 of the toothbrush pen 100 with the pen tip 121 retracted according to the present disclosure. FIG. 5 illustrates views of the pen tip 121 of the toothbrush pen 100 with the pen tip 121 retracted and extended according to the present disclosure.

As shown in FIGS. 3 and 5, in some implementations, the pen tip 121 is configured to twist to retract and extend the writing tip 123 of the toothbrush pen 100. Furthermore, in some implementations, the pen tip 121 is configured to house and houses an ink chamber 124 that is operatively connected to the writing tip 123.

As discussed above, in some implementations, the pen tip 121 is configured to attach to the closed end 122a of the hollow barrel 122. Thus, unlike traditional pens, in some implementations, the ink of the toothbrush pen 100 is not housed in the barrel 122 but instead outside the barrel 122. When retracted, the writing tip 123 of the toothbrush pen 100 is inside the pen tip 121. In some implementations, when extended, the writing tip 123 extends from the pen tip 121 for writing.

As shown in FIG. 4, in some implementations, the toothbrush apparatus 140 comprises a toothbrush head 141 fluidly connected to a toothpaste chamber 142 which is configured to house and housing toothpaste. In some implementations, the toothbrush head 141 comprises brushes for brushing a user's teeth.

In some implementations, the toothbrush apparatus 140 further comprises an elongated knob 143 extending from the end of the toothpaste chamber 142. In some implementations, the toothbrush apparatus 140 is configured to dispense toothpaste from the toothpaste chamber 142 to the toothbrush head 141 when the elongated knob 143 is twisted.

In some implementations, the toothbrush apparatus 140 is configured such that when the elongated knob 143 is twisted, the toothpaste in the toothpaste chamber 142 is pushed through a tube 144 extending from the toothpaste chamber 142 to the toothbrush head 141.

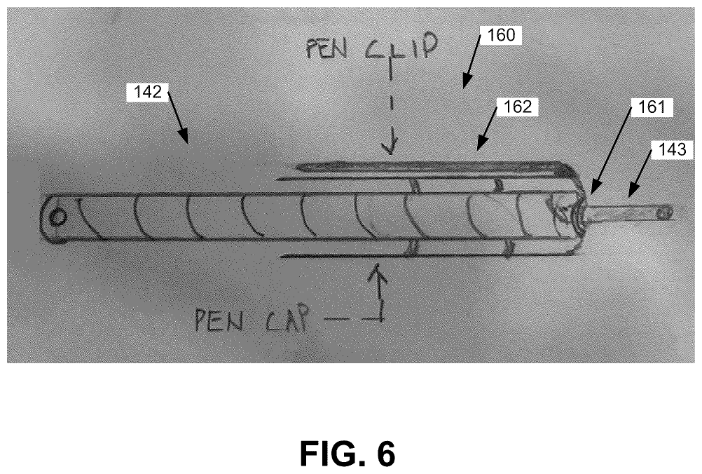

FIG. 6 illustrates a view of the toothbrush pen 100 showing the portion of the toothbrush apparatus 140 that is housed by the pen cap 160 and by the pen barrel 122 (not shown), which is received by the pen cap 160 (such as shown in FIG. 7), according to the present disclosure. As shown in FIGS. 2 and 6, in some implementations, one end of the pen cap 160 is configured to receive, house, and securely hold a portion of the toothpaste chamber 142 by inserting the toothpaste chamber 142 into the pen cap 160.

As shown in FIGS. 2 and 4, in some implementations, the pen cap 160 includes a smaller opening 161 on the opposite end of the pen cap 160 to receive the elongated knob 143 extending from the toothpaste chamber 142. In some implementations, as the toothpaste chamber 142 is inserted into the pen cap 160, the elongated knob 143 can extend from the pen cap 160 as shown in FIGS. 1, 2, 6, and 7.

As shown in FIGS. 2 and 6, in some implementations, the pen cap 160 is configured to securely hold the toothpaste chamber 142. In this way, in some implementations, when the toothbrush apparatus 140 is removed from the barrel 122 of the pen apparatus 120 (such as shown in FIG. 2), the toothpaste chamber 142 can be held by a user as a handle while brushing the user's teeth.

As shown in FIGS. 1 and 7, in some implementations, the pen cap 160 is sized to receive the barrel 122 of the pen apparatus 120.

As shown in FIG. 1, in some implementations, when the toothbrush apparatus 140 is housed inside the hollow barrel 122 of the pen apparatus 120 on one end and housed within the pen cap 160 on the opposite end, the toothbrush pen 100 looks and functions like a pen. The pen tip 121 may be twisted to extend the writing tip 123 for writing.

In some implementations, the toothbrush pen 100 is an apparatus that looks and functions like a pen but also houses a toothbrush. In some implementations, the toothbrush pen 100 also houses toothpaste. In some implementations, the toothbrush pen 100 can apply the toothpaste to the toothbrush.

In some implementations, the toothbrush pen 100 is a novel apparatus comprising a pen apparatus 120 having an outer body 101 defining a hollow enclosure for housing a removable toothbrush apparatus 140.

In some implementations, the toothbrush pen 100 can be stored anywhere a pen can be stored (e.g., a shirt pocket, purse, etc.) and then can be easily retrieved to use as a toothbrush with toothpaste when needed. For example, as shown in FIGS. 1, 2, and 6, in some implementations, the pen cap 160 further comprises a pen clip 162 that can be used for storage of the toothbrush pen 100.

In this way, in some implementations, a toothbrush and toothpaste are readily available whenever a user needs it to brush his/her teeth, such as after eating.

In some implementations, the toothbrush pen 100 comprises any suitable dimensions. For example, in some implementations, the toothbrush pen 100 comprises dimensions that are generally the same or similar to a writing pen, such that the toothbrush pen 100 can be stored like a writing pen (e.g., in a shirt pocket, purse, etc.) and then can be easily retrieved to use as a toothbrush when needed.

In some implementations, the toothbrush pen 100 is composed of any suitable materials.

In some implementations, the toothbrush pen 100 can have any suitable appearance.

In some implementations, an example method of using the toothbrush pen 100, with respect to the above-described figures, comprises pulling the toothbrush apparatus 140 from the hollow barrel 122 of the pen apparatus 120, such as shown in FIG. 2. In some implementations, the method comprises using the toothbrush apparatus 140 to brush the user's teeth, such as by using the toothbrush head 141 with toothpaste applied from the toothbrush chamber 142 as described above.

In some implementations, the method further comprises returning the toothbrush apparatus 140 into the hollow barrel 122 of the pen apparatus 120 for storage after using the toothbrush apparatus 140 to brush the user's teeth. In some implementations, the method further comprises then using the toothbrush pen 100 as a writing pen, such as by extending the writing tip 123 from the pen tip 121 as described above.

In some implementations, the method further comprises storing the toothbrush pen 100 anywhere a pen can be stored, such as a shirt pocket, purse, etc. and then retrieving the toothbrush apparatus 140 as described above to use as a toothbrush with toothpaste when needed to brush the user's teeth, such as after eating.

I claim a toothbrush pen comprising a pen apparatus, a toothbrush apparatus, and a pen cap.

I claim a toothbrush pen apparatus that looks and functions like a pen but also houses a toothbrush, may also house toothpaste, and may also apply the toothpaste to the toothbrush for brushing a user's teeth.

I claim a method of using the toothbrush pen comprising removing the toothbrush apparatus from the pen apparatus and using the toothbrush apparatus to brush a user's teeth and further comprising returning the toothbrush apparatus into the pen apparatus and using the toothbrush pen as a writing pen.

The figures, including photographs and drawings, comprised herewith may represent one or more implementations of the toothbrush pen.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A toothbrush pen comprising:
pen apparatus comprising a pen tip and a pen barrel wherein the pen barrel comprises a hollow elongated cylinder having a closed end and an opposite, open end into the interior of the hollow elongated cylinder, wherein the pen barrel and the pen cap form the outer body of the toothbrush pen;
a toothbrush apparatus comprising a toothbrush head comprising bristles and an elongated toothpaste chamber for holding toothpaste attached to the toothbrush head; wherein:
the open end of the pen barrel is configured to receive and house a portion of the toothbrush apparatus by receiving the toothbrush head and the elongated toothpaste chamber into the open end of the pen barrel; and
the pen tip attaches to the closed end of the pen barrel and houses ink.

2. A toothbrush pen comprising:
a pen apparatus having an outer body defining a hollow enclosure for housing a removable toothbrush apparatus.
